(19) United States
(12) Patent Application Publication
(10) Pub. No.: US 2021/0090157 A1
(43) Pub. Date: Mar. 25, 2021

(54) Sales Associate Customer Matching System

(71) Applicants: Allon Caidar, San Diego, CA (US); David Caidar, San Diego, CA (US)

(72) Inventors: Allon Caidar, San Diego, CA (US); David Caidar, San Diego, CA (US)

(21) Appl. No.: 16/582,386

(22) Filed: Sep. 25, 2019

(51) Int. Cl. G06Q 30/06; G06Q 30/00

(52) U.S. Cl. CPC G06Q 30/0641; G06Q 30/0629; G06Q 30/016

(57) ABSTRACT

A method matching a store sales associate to buyers of products from a retail store where the sales associate generates a coded tag with a product identifier thereon which the buyer can use subsequently to order the product. Using a tag identifier located on the coded tag input to the website of the retailer of the products, the buyer can purchase the product identified by the product identifier subsequent to their trip to the retail store and receiving the coded tag from the sales associate. The sales associate generating the coded tag employed for a subsequent purchase of a product identified by the product identifier is designated as a personal advisor to the buyer for information concerning similar products in the future.

### BACKGROUND OF THE INVENTION

### 1. Field of the Invention

The invention herein disclosed relates generally to the field of retail sales. More particularly it relates to a system enabling in-store customers to more easily order products subsequently online and concurrently associate themselves with the in-store sales associate for current and future product sales.

### 2. Prior Art

### BACKGROUND OF THE INVENTION

In recent years the demise of brick and mortar stores and sales of products therein has been widely predicted. However, more recently, online stores with brick and mortar sales and delivery capability have been making a comeback due to the ability of customers to order products online and pickup and return them at a local store of the same online vendor.

In some cases, brick and mortar sales establishments actually have an advantage over online retailers. Such is especially true for clothing, housewares, appliances, and other products where physical inspection and review by a buyer is important.

In the area of clothing sales, observing and keeping up with current fashion are imperative to most buyers. Further, because different fashion manufacturers employ different fabrics and have differing dimensions even to standardized sizes, the ability to feel, touch, and try on clothing at a local store, is a huge advantage for selling such products over internet retailers who can only provide videos and photos and text describing the various products.

Another example occurs in the field of housewares such as linens, tableware, and kitchen appliances. There is great personal preference involved in choosing linens and tableware which involves the feel of the products as well as their appearance. Appliances also require the ability to personally review the physical product to ascertain if the quality and appearance and functionality will work for the home or office of the buyer.

The additional advantage of physical stores stocking products over their online competitors, is the presence of sales associates in the various product departments who are familiar with the products they sell and who can offer advice. Such is the case in clothing where a knowledgeable sales associate can offer sage advice on what clothing products to buy and can also show a buyer other options based on the original product sought by the buyer. Another example would be an appliance sales associate who can aid a buyer in picking the right appliance for their particular use based on years of experience. Indeed, a knowledgeable and experienced sales associate for any type of product line category, be it housewares, sports equipment, or clothing or fashion, can provide advice to buyers which significantly enhances their final choice of the product to purchase.

As a consequence, brick and mortar retailers who stock such products whereby buyers can physically touch and see the various options for such, have an advantage in these areas over strictly online sales establishments. Such an advantage over computerized online sales is further enhanced where the physical retail store has sales associates who can aid and steer a buyer to a better choice of purchase.

However, physical product advantage is significantly reduced where the brick and mortar retailer does not have the ability to stock all sizes and colors of various fashions or all models of various appliances. Further, because many sales associates in such brick and mortar establishments receive commissions on sales, the lack of a product available for purchase in the store, significantly reduces the sales associates interest in providing advice should that advice be to order from the store, but do so online. There is no system in place or available to encourage the sales associate to offer such online purchase advice where they will not receive any credit for making sales nor any commission should such be available.

As a consequence, sales associates in brick and mortar establishments would rather steer customers to products on the floor and available rather than offer the ability to order the product with the proper color, size, or other attribute sought by the buyer, online. Thus, the brick and mortar retailer loses sales to buyers who cannot find the product to their liking in stock. The sales associates lose the inducement to provide advice to customers on purchases online since they receive no credit for such, and lose the long term personal contact with the customer. Further, the customer loses the ability to work long term with a knowledgeable sales associate for the products they buy over time.

The system herein is configured to provide ongoing sales to customers who visit brick and mortar stores and encourage sales associates to aid in such and to further provide the customer with the ability to regularly seek advice and purchases from sales associates who can provide experienced advice for both online and in store sales over time.

With respect to the above, before explaining at least one preferred embodiment of the system herein for matching buyers with sales associates and encouraging in store and online sales herein in detail or in general, it is to be understood that the system invention is not limited in its application to the details of employment and to the arrangement of the components or the steps set forth in the following description or illustrated in the drawings. The various apparatus and methods and steps of the herein are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other sales associate and customer matching. It is important, therefore, that the embodiments, objects and claims herein, be regarded as including such equivalent construction and methodology insofar as they do not depart from the spirit and scope of the present invention.

### SUMMARY OF THE INVENTION

The disclosed system herein, provides for the enhancement of sales to buyers who visit brick and mortar stores. The system operates through the provision of a sales associate and buyer association system which is configured to encourage sales associates to sell both in store and online products from their establishment through the provision of a matching of the buyer to the sales associate for purchases of such products.

In the system herein, buyers of products who visit brick and mortar stores to feel, view, and touch such products during choosing a product to purchase, will benefit significantly from sales associate advice. Such advice by sales associates is encouraged whether the product is physically present or where it is not stocked but is available through an online purchase. Further, the system provides a matching of the sales associate for a particular type of product, for example fashion, once the buyer purchases a sales associate suggested product online, or in the store.

A key object of the system herein is providing the inducement to sales associates to provide buyers with advice on products and alternatives to such, whether such are available in the store, or must be ordered by a buyer online subsequent to leaving the store. Currently, if a sales associate, for example, indicates a particular shirt sold in the store in the wrong color, is available in a different color sought by the customer online, the sales associate receives no credit for the sale, and it is common that subsequently the customer forgets to order the product. In some cases, the customer might remember the advice to buy online, but forgets key facts about the product which are required to order online. These issues are solved in the system herein through the provision of a tag which includes a scannable code or user-entered product identifier, which when employed by the customer online, will immediately bring the exact product desired for purchase on the display screen where that product has the sought attributes which were lacking in the stocked item. The tag, once scanned or once the code thereon is entered, using software operating to the task, concurrently associates the sales associate who provided the tag to the buyer, with the buyer, and with the sale of the product, whereby they earn credit or commission for that sale.

Thus, sales associates working in the store are encouraged by the prospect of earning credit and/or commissions for online sales to customers they help in the store. Rather than trying to sell the customer something less than perfect because it is in the store, they can be confident if they generate a scannable ticket that the customer can buy exactly what they want, and the sales associate is credited for the help they provided. Further, sales for the retailer are increased by providing the easy ability for the buyer, once they leave the store, to scan a ticket and bring the exact product sought to a sales screen for purchase.

An additional object of the system is the creation of a long term relationship between the buyer and sales associate which benefits both. In this step, once a ticket is scanned and a product related to the ticket is purchased, not only does the sales associate get credit for the sale, they are also associated to the individual buyer as an advice providing sales associate for the type of product purchased by the customer. Thus the customer will have sales associates associated to their account who they know have provided advice in the category of product they purchase. The sales associate by being associated with an individual customer, will have the ability to communicate with them in the future concerning arriving products and inside information concerning such, in order to encourage the customer to make further purchases based on a known sales associate's advice.

As such, customers are provided significant advantages of being able to view merchandise and purchase, if it's in stock, or easily order it in a form to their liking, if not in stock. Sales associates are provided encouragement to show customers every product which may meet the needs of the customer, irrespective of whether all types are in stock since they get credit from a ticket scan sale. Finally, the retailer benefits from more sales since customers are provided sales associate advice in the store, and can order based on that advice easily, even if the product is not in the store.

With respect to the above description, before explaining at least one preferred embodiment of the sales system herein, it is to be understood that the invention is not limited in its application to the details of operation nor the arrangement of the components or the steps set forth in the following description or illustrations in the drawings. The various methods of implementation and operation of the method herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of methods and systems for carrying out the several purposes of the present method. Therefore, that the objects and claims herein should be regarded as including such equivalent construction, steps, and methodology insofar as they do not depart from the spirit and scope of the present invention.

It is an object of this invention to provide a system to encourage interaction between sales associates in retail stores and customers which results in increased sales to the retailer, easier ordering by the buyer, and inducement to the sales associate to provide advice for both in stock and online products.

It is a further object of the invention to provide such a system which concurrent to a finalized product sale initiated by a sales associate generated tag, creates an association between the buyer and the sales associate for long term interaction to increase customer satisfaction as well as creditable sales to the sales associate.

These together with other objects and advantages which become subsequently apparent reside in the details of the construction and operation of the system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 shows a flow chart of the method and system herein wherein customers to brick and mortar stores are advised by sales associates and provided with a scanable ticket to order products not present in the store.

FIG. 2 shows an example of a typical scanable ticket which can be provided customers by a sales associate and employed by the customer subsequently to order the exact product sought and concurrently give the sales associate credit for the sale and a designation as a sales adviser who may be subsequently contacted by the customer for advice.

### DETAILED DESCRIPTION OF THE PREFERRED EMBODIMENTS OF THE INVENTION

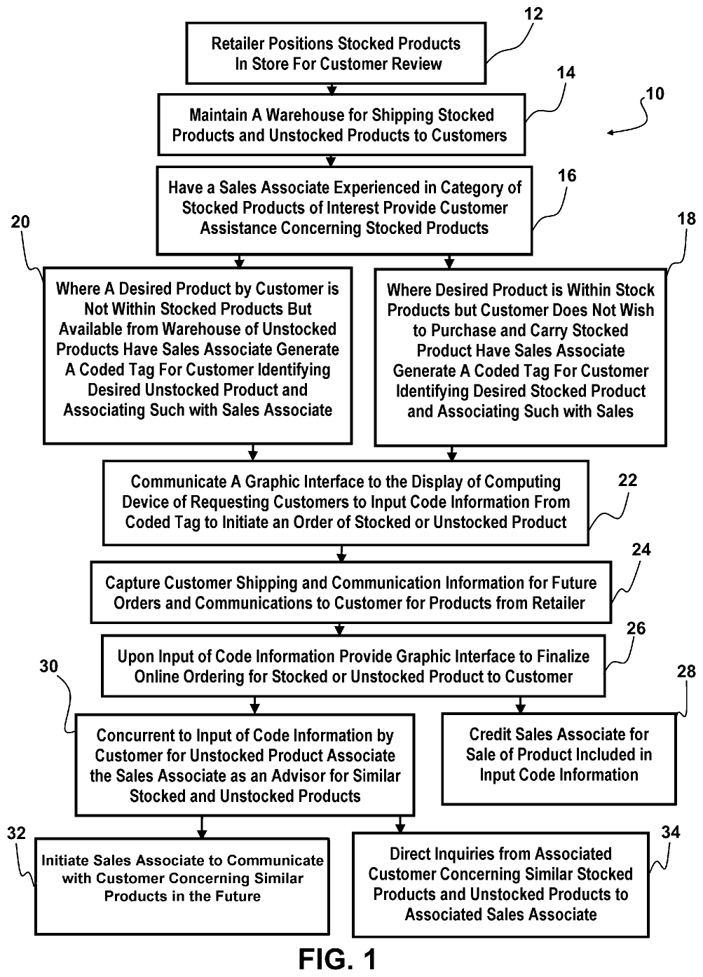

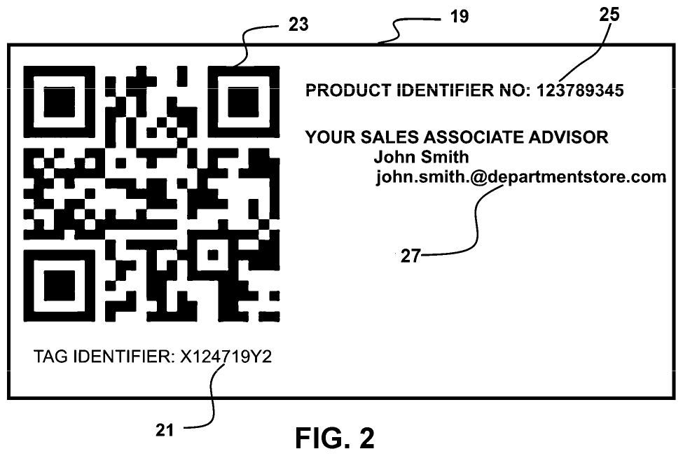

Referring now to the method and system herein shown in simple format by the depictions of both FIGS. 1-2. It should be noted that in all modes of the system herein, the system provider which in this case will be the product retailer or a contractor for a product retailer, will employ a computer or server in operational communication over a network such as the internet, which is accessible by the computing devices of buyers. The system provider will employ computing devices having electronic memory in which software adapted to perform the tasks of the steps in the system herein on an ongoing basis.

In the system 10 herein, product retailers for goods and services desired for purchase by buyers, will in a brick and mortar store, stock products 12. Additionally, such product retailers will maintain stocks of the product available in the retail stores in a warehouse 14 which may have storage of both the products sold and stocked in the retail store as well as versions of the products not stocked in the retail stores.

Such products with most product retailers, are positioned in sections of the retail store in categories of products where each category of products are a plurality of similar products sold in the individual category. For example, but in no way limiting, categories can include clothing for men women and children, footwear such as shoes, housewares such as dinnerware and kitchen appliances, appliances such as dishwashers and washing machines, electronics such at televisions and media players. Consequently category as used herein, means the conventional product category employed by product retailers in stores where products of a similar nature are displayed for sale. Within any category of similar products will be sold different brands of the same product, such as for example in clothing, there exist many different brands of shirts, pants, dresses, and other clothing, but all are in a product category of clothing, which is conventionally positioned within a store and the same area.

Conventionally, selling products within the product categories in areas of the retail store, there will be sales associates positioned in each respective area, during business hours, who are experienced in the product category, and provide buyers customer assistance concerning stocked products in the retail store in their category of expertise 16. Such sales associates are conventionally trained in their category of expertise and are knowledgeable as to the products stocked in the store in their category of expertise as well as other products which may be purchased from the same retailer, but are not physically stocked in the brick and mortar store, but in a warehouse.

In such instances, the sales associate may provide the buyer a coded tag 19 (FIG. 2) having a tag identifier which is alphanumeric 21 or readable code 23, specific to each respective individual coded tag 19, and also the product identifier 25 identifying the specific un-stocked product of interest, and an identification 27 of the sales associate matching the sales associate on the coded tag 19, to the identified product of interest in step 20.

In other instances, where a desired product is stocked in the store of the product retailer, but the buyer does not wish to buy it in the store and carry it home, the sales associate working with the buyer in the category of product in the store, will generate the coded tag 19 shown in FIG. 2 for example, having a unique tag identifier 21 or 23, for the buyer, with the coded tag 19 also having product identifier 25 of the product wanted for purchase by the buyer, and also associating the sales associate 27 on the coded tag 19, with the identified product on the tag, in step 18.

In either instance, during generation and issuance of the coded tag 19 shown in an example in FIG. 2, by the sales associate in step 18 or 20, the tag identifier 21 or 23 on the coded tag 19 of FIG. 2, and associated product identifier 25 and sales associate identifier 27, are all correlated and stored in computer memory on the computing system of the product retailer.

The buyer having the coded tag 19 in an example in FIG. 2 in their possession, in a next step 22, upon an internet or other network contact with the server or computers of the product retailer, is communicated from the server of the product retailer over a network such as the internet, an input graphic interface depictable on the display of a computing device of the buyer. The input graphic interface is configured to allow the buyer to input the tag identifier 21 or 23 on the coded tag 19 in their possession. Following step 22, upon input of the tag identifier 21 or 23, the computing system of the product retailer will lookup an electronic record of the coded tag 19 stored in electronic memory, and provide the buyer a graphic interface to purchase the product or products associated with the product identifier 25 on the coded tag 19 as depicted for example in FIG. 2.

The buyer may be a registered user of the network-accessible computing system of the product retailer in which case their shipping address and electronic communication information will be known to the product retailer. Where the buyer is not registered with the product retailer they will input their respective electronic communication information such as email and telephone, and also input their shipping address. In either scenario, the buyer contact, shipping, and communication information, is stored in a correlation with the tag identifier 21 or 23 from the coded tag 19 used, so that the product ordered using the tag identifier 21 or 23 from a tag such as in FIG. 2, are associated to the buyer for future purchases and communications between the buyer and the product retailer 24.

After the buyer information is input or ascertained as known, upon input of the tag identifier 21 or 23 from the coded tag 19 such as in FIG. 2, in a next step 26, a graphic interface will be communicated to the buyer, to finalize an online purchase of the products on or associated to the coded tag by the product identifier.

In a next step in the system 30, upon input of the tag identifier 21 or 23 from the coded tag 19 such as in FIG. 2, identifying the stocked or un-stocked product to be purchased, the sales associate associated to the tag 27, by tag identifier 21 or 23, and the products identified by product identifier 25, is stored in memory of the product retailer as an advisor to the identified buyer, for other products in the category of products being purchased by product identifiers 25 on the coded tag 19 such as shown in FIG. 2.

Upon future logins by the buyer, to the product retailer website, a link to the sales associate will be displayed to the buyer as being available for communication with the buyer for advice on the same or other products in the category of product as that shown in the product identifier 25 of a previous tag 19. This can be by a hotlink placed on a customized dashboard of the graphic interface associated with each respective buyer, and thereafter communicated to each identified buyer on login.

In another step 28, concurrent with matching the sales associate who generated to coded tag 19 such as in FIG. 2, to the buyer for the category of products listed in the product identifier on the coded tag, the sales associate will receive credit for the sale of any product listed on the coded tag 19 by product identifier 25. This insures the sales associate will receive credit and/or monetary remuneration for taking the time to work with the identified buyer and generating the coded tag 19 in the store, for the buyer to subsequently employ for the purchase. This step 28 also provides the sales associate with a financial inducement to help buyers and generate coded tags 19 for them where products can be shipped to the buyer later, since they get credit for the sale. Currently, there is no such inducement and a sales associate receives no credit when a buyer, helped by that sales associate, leaves the store and purchases a product.

With the sales associate being matched to the buyer identified as having input the tag identifier 21 or 23, and having the buyer communication information stored in a database and associated to the buyer, and having the sales associate associated to the buyer for the category of product purchased, the system will initiate communications from the sales associate to the buyer in the future concerning similar products in the category related to the sales associate, shown as step 32. Such will allow the sales associate to become an ongoing advisor to the buyer on a continuous basis to provide advice concerning the products in the category associated to the sales associate for each buyer 32.

Finally, in an additional step 34, on subsequent inquiry or communication from a buyer to the retailer website, who has been associated to a sales associate for a particular category of products, that buyer will automatically be directed to the sales associate who has been associated to the known buyer for the category of products. This step 34 will encourage buyers to take advantage of the experience and knowledge of the sales associate who has been matched to the buyer for the category of products of interest on an ongoing basis. Familiarity with a particular sales associate for particular categories of products from a retailer of such products, has in experimentation shown to yield increased sales of products to buyers, as well as increased satisfaction of the buyers with the products purchased pursuant to the advise of their assigned sales associate.

While all of the fundamental characteristics and features of the system for encouraging sales associate sales and in store and online sales, has been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

1-6. (canceled)

7. A method of providing customers visiting a retail store with a coded tag to take with them upon leaving the store, which is employable for a subsequent order of products encoded thereon and which credits a store sales associate for such a subsequent order, comprising:
having a sales associate located within a retail store assist a buyer visiting the retail store, in a determination of a product to be purchased, from said products located within said retail store;
employing software running on a store computer employed by said retail store, which is configured to the task of generating a coded tag having a tag identifier thereon and a product identifier thereon identifying the product to be purchased, by the buyer;
employing software running on said store computer, operating to the task of storing said tag identifier of said coded tag in electronic memory of the store computer, in a tag identifier file which is matchable to said tag identifier, and which includes said product identifier of said product to be purchased, and a sales associate identifier of said sales associate;
tendering said coded tag to the possession of said buyer to take with them upon leaving said retail store;
employing software running on said store computer operating to the task of generating an input graphic interface, which is depictable on a display of a computing device of said buyer, which is configured for an input of said tag identifier by said buyer;
communicating said input graphic interface over a network to said computing device of said buyer for said input of said tag identifier by said buyer;
employing software running on said store computer which operates to the task of receiving said tag identifier from said coded tag, input to said input graphic interface by said buyer in possession of said coded tag, to determine a matching tag identifier file, held in said memory;
employing software running on said store computer to review the matching tag identifier file and to ascertain the product to be purchased, from the product identifier associated therein;
employing software running on said store computer operating to the task of generating a purchasing graphic interface, for said product to be purchased, which was determined to be associated in said matching tag identifier file; and
communicating said purchasing graphic interface over said network to the computer display of the buyer, for said buyer to input an order to buy the product to be purchased, which was determined to be associated in the matching tag identifier file with the product identifier.

8. The method of claim 7, additionally comprising:
upon input of said order to buy said product to be purchased, employing software running on said store computer operating to the task of reviewing the matching tag identifier file and determining the sales associate having the sales associate identifier held therein and crediting the sales associate who generated the coded tag for the buyer for a commission on the order to buy the product to be purchased.

9. The method of claim 7, additionally comprising:
employing software running on the store computer operating to the task of designating the sales associate associated in the sales associate identifier in the tag identifier file as an advisor to the buyer for future purchases; and
communicating a buyer graphic interface over said network to the computer display of the buyer which positions a hot link thereon to connect said buyer with said advisor.

10. The method of claim 8, additionally comprising:
employing software running on the store computer operating to the task of designating the sales associate associated in the sales associate identifier in the tag identifier file as an advisor to the buyer for future purchases; and
communicating a buyer graphic interface over said network to the computer display of the buyer which positions a hot link thereon to connect said buyer with said advisor.

11. The method of claim 7, additionally comprising:
employing software running on said store computer to communicate an informational graphic interface displayable on said computing device of said buyer, to input an electronic address for said buyer;
storing said electronic address in said tag identifier file; and
employing communication software running on said store computer to send future communications relating to the product identified by the product identifier on the coded tag or similar products thereto, to the buyer using the electronic address for communicating with the buyer.

12. The method of claim 8, additionally comprising:
employing software running on said store computer to communicate an informational graphic interface displayable on said computing device of said buyer, to input an electronic address for said buyer;
storing said electronic address in said tag identifier file; and
employing communication software running on said store computer to send future communications relating to the product identified by the product identifier on the coded tag or similar products thereto, to the buyer using the electronic address for communicating with the buyer.

13. The method of claim 9, additionally comprising:
employing software running on said store computer to communicate an informational graphic interface displayable on said computing device of said buyer, to input an electronic address for said buyer;
storing said electronic address in said tag identifier file; and
employing communication software running on said store computer to send future communications relating to the product identified by the product identifier on the coded tag or similar products thereto, to the buyer using the electronic address for communicating with the buyer.
